(19) United States
(12) Patent Application Publication
(10) Pub. No.: US 2011/0051598 A1
(43) Pub. Date: Mar. 3, 2011

(54) Loss Link Forwarding

(76) Inventors: Jonathan Oldershaw, Nottinghamshire (GB); James Hayden, Derbyshire (GB); Steven Chapman, Nottinghamshire (GB)

(21) Appl. No.: 12/867,346

(22) PCT Filed: Feb. 15, 2008
(86) PCT No.: PCT/EP2008/051893

§ 371 Date: Nov. 16, 2010

(51) Int. Cl. H04L 12/26

(52) U.S. Cl. 370/221

(57) ABSTRACT

The invention provides a loss link forwarding method for a telecommunications network having a first group of cables, a second group of cables corresponding to the first group, the first and second groups being connected via a network cable. The method comprises in the event of failure or disconnection of a cable from the first group, transmitting a failure signal to the second group indicating that said cable of the first group of cables has failed or been disconnected, and disabling only the or each corresponding cable of the second group.

### TECHNICAL FIELD

The present invention relates to loss link forwarding in a telecommunications network.

### BACKGROUND

FIG. 1 schematically shows a telecommunications network 10. The network 10 comprises a first group of Ethernet cables 12, 13, 14, 15, 16, connected via a network cable—an SDH cable 20—to a second group of Ethernet cables 22, 23, 24, 25, 26. This is standard network architecture. Signals (including data packets) sent from or through the first group of cables 12, 13, 14, 15, 16, are transported via the SDH cable 20 and passed to the second group of cables 22, 23, 24, 25, 26.

When one of the cables 12, 13, 14, 15 or 16 fails or is disconnected (intentionally or unintentionally) from the SDH cable 20, a failure/disconnection message is transmitted to the second group of cables 22, 23, 24, 25 and 26. This is in the form of an LLF (link loss forwarding) message. The LLF message is in the form of a client signal fail (CSF) signal which indicates that a failure/disconnection has occurred in the first group. The CSF signal is transmitted across the SDH connection and reaches the second group of Ethernet cables 22, 23, 24, 25, 26. The CSF signal has the effect of disabling the entire second group of cables 22, 23, 24, 25, 26 such that no signals can be transmitted through them. There are two main problems with the prior art solutions. First, the signal can only be sent along the SDH part of a path. The signal may go through a number of native Ethernet hops subsequent to, or in between SDH paths, in which case the implementation known in the art will fail. Second, if the signal is part of an Ethernet Virtual Private Line service there is no way of signalling individual ports within one VCG since the CSF signal is sent per VCG. This is very significant. Three customers could share a single VCG, but with the current implementation, there is no way of signalling a link-down event per customer.

### SUMMARY

According to a first aspect of the invention there is provided a loss link forwarding method for a telecommunications network having a first group of cables, a second group of cables corresponding to the first group, the first and second groups being connected via a network cable. The method comprises transmitting a failure signal to the second group indicating that said cable of the first group of cables has failed or been disconnected, in the event of failure or disconnection of a cable from the first group and disabling only the or each corresponding cable of the second group.

According to a second aspect of the invention there is provided a telecommunications network comprising a first group of cables, a second group of cables corresponding to the first group and the first and second groups being connected via a network cable. The network comprising a loss link forwarding system arranged to, in the event of failure or disconnection of a cable from the first group, transmit a failure signal to the second group indicating that said one of the first group of cables has failed or been disconnected, and disable only the or each corresponding cable of the second group.

According to a third aspect of the invention there is provided a network element for use in a telecommunications network. Said network element comprises ports for connecting a first group of cables and a port for connecting a network cable. The network element operates under control of a loss link forwarding system arranged to, in the event of a failure or disconnection of a cable from the first group, transmit a failure signal to a second group of cables corresponding to the first group of cables. The first and second groups are connected via a network cable, and said second group is connected to said network cable in another network element. Said failure signal indicates that one of the first group of cables has failed or been disconnected, and to disable only the or each corresponding cable of the second group.

According to a fourth aspect of the invention there is provided a method of operating a telecommunications system comprising using an Ethernet AIS signal as a Loss Link Forwarding signal in said telecommunications system.

Further features of the present invention are as claimed in the dependent claims.

Advantageously, since only cables of the second group that correspond to failed/disconnected (non-working) cables of the first group are disabled, the other cables of the second group that are still useful are allowed to remain in use to accept data traffic. This improves better network performance when compared with solutions known in the art where if the link no longer passes traffic but the link is “up” at the router, the routing protocols will need to determine that this path is unavailable. This can take a number of minutes, where operation with the link down according to the present invention is immediate.

### BRIEF DESCRIPTION OF THE DRAWINGS

FIG. 1 is a schematic representation of a communications network;

FIG. 2 is a flowchart representing a link loss forwarding method in one embodiment of the invention;

FIG. 3 is a diagram illustrating a network element in one embodiment of the invention

### DETAILED DESCRIPTION

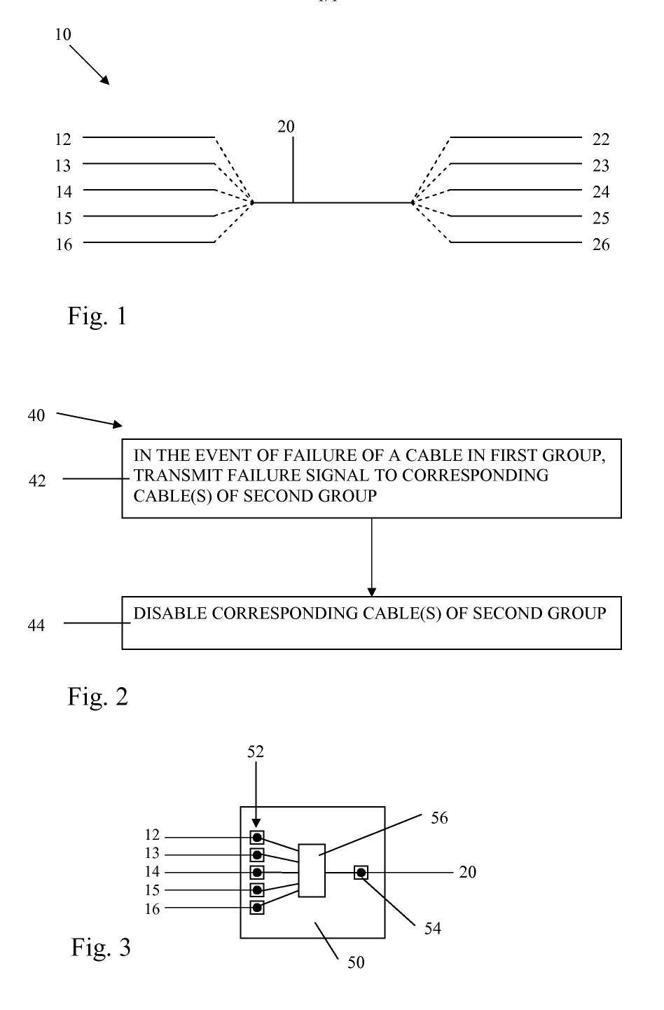

Referring to FIG. 1, the standard network architecture operates conventionally as outlined above. In this embodiment the first group of cables comprise five Ethernet cables 12, 13, 14, 15 and 16. These cables carry signals in the form of data packets for transmission over an SDH network—over a network SDH cable 20. In this embodiment there are five Ethernet cables 22, 23, 24, 25 and 26 in the second group. In this embodiment each of the cables of the second group corresponds to a cable of the first group. Cable 22 corresponds to cable 12, cable 23 corresponds to cable 13, cable 24 corresponds to cable 14, cable 25 corresponds to cable 15 and cable 26 corresponds to cable 16. This means that data packets input through cable 12 travel through the SDH cable 20 and are then routed to cable 22. Data packets that are input through cable 14 travel through the SDH cable 20 and are then routed to cable 24, and so on.

In this embodiment the data packets travelling through the cables of the first group are tagged with VLAN (virtual local area network) tags which indicate their origin (and thus required destination). For example, data packets from a first VLAN travelling along cable 12 are tagged with ‘VLAN1’, data packets from a second VLAN travelling along cable 14 are tagged with ‘VLAN2’. In other embodiments other suitable tags can be used.

In other embodiments more than one cable of the second group may correspond to a cable of the first group, e.g. data packets sent through cable 12 might be routed to cable 22 or cable 24, perhaps depending upon their VLAN tag information—e.g. they are routed to cable 22 if they are tagged ‘VLAN.x’ or to cable 24 if they are tagged ‘VLAN.y’.

Referring to FIG. 2, according to an embodiment of this invention, there is provided a loss link forwarding method 40 used over the network 10 shown in FIG. 1.

At step 42, when a failure (or disconnection, whether intentional or unintentional) occurs within a cable of the first group, a failure signal is transmitted to the second group indicating that said one of the first group of cables has failed or been disconnected. In this embodiment the failure signal is transmitted only to the relevant, corresponding cables of the second group. In other embodiments the failure signal may be transmitted to all cables or to more cables than just the corresponding cables, of the second group.

In this embodiment the Ethernet cables provide an Ethernet OAM structure and the failure signal comprises an Ethernet alarm indication signal (AIS).

In some embodiments an AIS is sent in the event of total failure. In other embodiments an AIS signal is sent if a cable is not receiving enough continuity check messages (CCMs). In such an embodiment, the AIS may be sent from a maintenance endpoint (MEP). CCM and MEP formats are known from EthOAM standard ITU Y.1731.

At step 44 the LLF method comprises disabling the corresponding cables of the second group. Therefore in this embodiment if cable 12 is disconnected, cable 22 is disabled at step 44. In another embodiment where data packets sent through cable 12 might be routed to cable 22 or cable 24, then both cables 22 and 24 would be disabled at step 44.

In yet further embodiments, at step 44 the corresponding cables of the second group are disabled along with some other non-corresponding cables, but one or more non-corresponding cables that are particularly important may remain enabled. This still offers an advantage over the existing CSF failure message system (discussed above) which effectively disables the entire second group if any one of the cables of the first group fails or is disconnected.

In some embodiments if the failed/disconnected cable is repaired or reconnected the failure signal transmission (e.g. the AIS) is ended and normal service resumes.

In one embodiment on detection of a link failure, an Ethernet OAM message is sent (rather than CSF), notifying the far end that there has been a link down event and that it should turn off its Ethernet port. Because Ethernet OAM can be associated with specific flows within a VCG using VLAN tags, each port can be signalled independently. This gives the present invention a major advantage over previous solutions which only have a single signalling mechanism (CSF) per VCG). The message used can vary, depending on the speed of detection required. It could be carried in a vendor specific TLV of the CCM frame. It could also be carried by a unique vendor specific “link loss” message. In a preferred embodiment, as indicated above, Ethernet AIS message to indicate loss of link. This can be sent by a server MEP immediately on detecting link down, and will be received by a MEP configured at the far end. Using this method, the delay from the near end link being down, to the far end shutting off its transmitter could be a matter of milliseconds.

FIG. 3 presents one embodiment of a network element for use in a telecommunications system which operates according to the method of the present invention. The network element 50 comprises a plurality of ports 52 for connecting a first group of cables 12-16, which in a preferred embodiment are Ethernet network cables and a port 54 for connecting a network cable 20. In a preferred embodiment the network cable is a SDH cable. Signals from the first group of cables are mapped in a mapping function unit 56 onto the SDH cable. The network element 50 operates under control of a loss link forwarding system arranged to, in the event of failure or disconnection of a cable from the first group 12-16, transmit a failure signal to a second group of cables corresponding to the first group of cables 12-16. The first and second groups are connected via the SDH cable 20, and said second group is connected to a second network element (not shown), wherein said failure signal indicates that one of the first group of cables 12-16 has failed or been disconnected and also provides instruction to the second network element to disable only the or each corresponding cable of the second group.

Various modifications may be made to this invention without departing form its scope.

It will be clear to the skilled person that this invention is equally applicable to networks where the SDH cable is replaced by a SONET cable, an Ethernet cable or any other suitable cable.

It will be appreciated that where a claim is provided in a particular category, its features are equally applicable to other categories (e.g. method, system, network, use, etc.) Features of the dependent claims in one category are equally applicable to other categories.

1. A loss link forwarding method for a telecommunications network having a first group of cables, a second group of cables corresponding to the first group, the first and second groups being connected via a network cable, the method comprising:
in the event of failure or disconnection of a cable from the first group, transmitting a failure signal to the second group indicating that said cable of the first group of cables has failed or been disconnected; and
disabling only the or each corresponding cable of the second group.

2. The method of claim 1, wherein the disabling step comprises disabling some, but not all, of the other cables of the second group.

3. The method of claim 1, wherein the transmitting step comprises transmitting the failure signal only to the cables of the second group that are to be disconnected.

4. The method of claim 1, wherein each cable in the second group corresponds to only one cable in the first group.

5. The method of claim 1, wherein the failure signal comprises an Ethernet AIS signal.

6. A telecommunications network comprising a first group of cables, a second group of cables corresponding to the first group, the first and second groups being connected via a network cable, the network comprising a loss link forwarding system arranged to, in the event of failure or disconnection of a cable from the first group, transmit a failure signal to the second group indicating that said one of the first group of cables has failed or been disconnected, and disable only the or each corresponding cable of the second group.

7. A network element for use in a telecommunications network, said network element comprising a plurality of ports for connecting a first group of cables and a port for connecting a network cable, the network element operating under control of a loss link forwarding system arranged to, in the event of failure or disconnection of a cable from the first group, transmit a failure signal to a second group of cables corresponding to the first group of cables, wherein the first and second groups are connected via a network cable, and said second group is connected to said network cable in another network element, wherein said failure signal indicates that one of the first group of cables has failed or been disconnected, and to disable only the or each corresponding cable of the second group.

8. A method of operating a telecommunications system comprising using an Ethernet AIS signal as a Loss Link Forwarding signal in said telecommunications system.
